(19) United States
(12) Patent Application Publication
(10) Pub. No.: US 2010/0135705 A1
(43) Pub. Date: Jun. 3, 2010

(54) PAPER GUIDING MECHANISM AND PRINTER USING THE SAME

(75) Inventors: Chia-Huei Lin, Taipei County (TW); Katsuhiko Gotoda, Hsinchu (TW)

Correspondence Address: COVENANT IP CONSULTING CO., P.O. BOX 34-306 TAIPEI CITY, TAIPEI, 10499, TW

(73) Assignee: AVISION INC., Hsinchu (TW)

(21) Appl. No.: 12/629,077

(22) Filed: Dec. 2, 2009

(30) Foreign Application Priority Data
Dec. 2, 2008 (TW) 97146848

(51) Int. Cl. G03G 15/20

(52) U.S. Cl. 399/322

(57) ABSTRACT

A paper guiding mechanism and a printer using the same are provided. The paper guiding mechanism is disposed in a casing of a printer and located at an exiting end of a fusing device of the printer. The paper guiding mechanism guides a recording medium to a paper exit of the printer. The paper guiding mechanism includes a first guiding member and a second guiding member. The first guiding member is disposed in the casing. The second guiding member is movably attached to the casing. A passage is formed between the first guiding member and the second guiding member for the recording medium to pass through. The second guiding member may be moved by the force applied by the recording medium to guide the recording medium through the passage.

This application claims the benefit of Taiwan application Serial No. 97146848, filed Dec. 2, 2008, the subject matter of which is incorporated herein by reference.

### BACKGROUND OF THE INVENTION

1. Field of the Invention

The invention relates in general to a paper guiding mechanism and a printer using the same, and more particularly to a paper guiding mechanism which eliminates the paper jam problem and prevents the corners of the recording medium from being folded in the printer, and a printer using such paper guiding mechanism.

2. Description of the Related Art

Compared with inkjet printers, laser printers provide high-speed and high-quality printing for both text and image. Thus, the laser printers are widely used as computer peripheral devices in both household and business for printing a large amount of document.

In a printing procedure, there is normally a step of fixing toner images on a recording medium, for example, a sheet of paper, through heating and pressurizing. In such step, two rollers are used: one is a heating roller for melting toners, and the other is a pressurizing roller for fixing toners on paper.

A paper guiding member is disposed to guide paper emerging from the rollers. Referring to FIG. 1, a conventional paper guiding member is shown. The fusing device 100 includes a heating roller 102 and a pressurizing roller 104. Paper 108 is in contact with the guiding member 106 after leaving the heating roller 102 and the pressurizing roller 104. The paper guiding member 106 guides paper 108 to a paper exit of the printer.

However, as indicated in FIG. 1, if paper 108 is thicker or heavier (that is, paper 108 is harder than regular printing paper), the leading edge 110 of paper 108 is not bendable to fit the curves in the plane of the guiding member 106, and thus paper 108 becomes folded as being obstructed by the guiding member 106, which may create the paper jam problem.

### SUMMARY OF THE INVENTION

The invention is directed to a paper guiding mechanism and a printer using the paper guiding mechanism. Through the use of a movable guiding member of the paper guiding mechanism, which moves in response to the pressure exerted by a sheet of paper passing through, paper will not be rumpled by the guiding member and may be delivered smoothly.

According to a first aspect of the present invention, a paper guiding mechanism is provided. The paper guiding mechanism is disposed in a casing of a printer and located at an exiting end of a fusing device of the printer. The paper guiding mechanism is used for guiding a recording medium to a paper exit of the printer. The paper guiding mechanism includes a first guiding member and a second guiding member. The first guiding member is disposed in the casing. The second guiding member is movably attached to the casing. A passage is formed between the first guiding member and the second guiding member for the recording medium to pass through. The second guiding member moves in response to a force applied by the recording medium and guides the recording medium through the passage.

According to a second aspect of the present invention, a printer including a casing, an imaging forming device, a fusing device, a paper guiding mechanism and a transporting mechanism is provided. The imaging forming device is disposed in the casing for forming a toner image on a recording medium. The fusing device is disposed in the casing for fixing the toner image onto the recording medium. The paper guiding mechanism is disposed in the casing and located at an exiting end of the fusing device for guiding the recording medium to a paper exit of the printer. The paper guiding mechanism includes a first guiding member and a second guiding member. The first guiding member is disposed in the casing. The second guiding member is movably attached to the casing. A passage is formed between the first guiding member and the second guiding member for the recording medium to pass through. The second guiding member moves in response to a force applied by the recording medium and guides the recording medium through the passage. The transporting mechanism is disposed in the casing for transporting the recording medium sequentially past the imaging forming device, the fusing device and the paper guiding mechanism, and then to the paper exit of the printer.

The invention will become apparent from the following detailed description of the preferred but non-limiting embodiments. The following description is made with reference to the accompanying drawings.

### BRIEF DESCRIPTION OF THE DRAWINGS

FIG. 1 shows a conventional guiding member;

FIG. 2 shows a printer;

FIG. 3 shows an enlargement of area A of FIG. 2 and an embodiment of a paper guiding mechanism;

FIG. 4 shows a second embodiment of the paper guiding mechanism; and

FIG. 5 shows a third embodiment of the paper guiding mechanism.

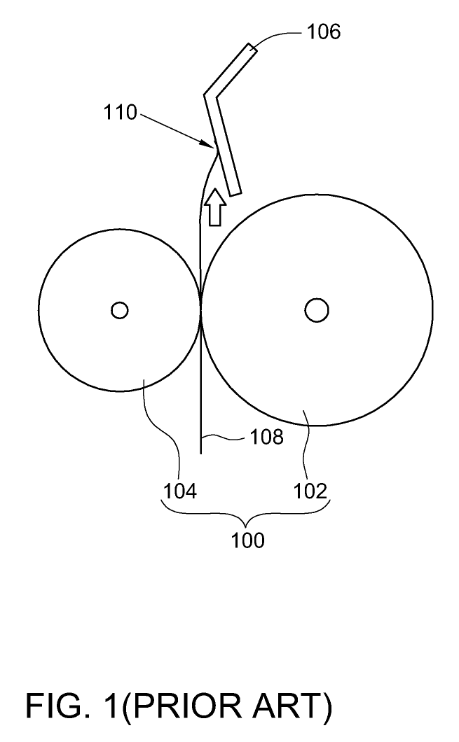

### DETAILED DESCRIPTION OF THE INVENTION

According to the present invention, the paper guiding mechanism includes a first guiding member and a second guiding member. The first guiding member is disposed in a casing. The second guiding member is movably attached to the casing. A passage is formed between the first guiding member and the second guiding member for a recording medium to pass through. The second guiding member moves in response to a force applied by the recording medium and guides the recording medium through the passage. The second guiding member of the paper guiding mechanism can prevent the recording medium from being crumpled and facilitate the recording medium to move smoothly.

A preferred embodiment is disclosed below for the illustration of the invention. However, the following embodiment is for exemplification only, not for limiting the scope of protection of the invention. Besides, secondary elements are omitted in the embodiment to highlight the technical features of the invention.

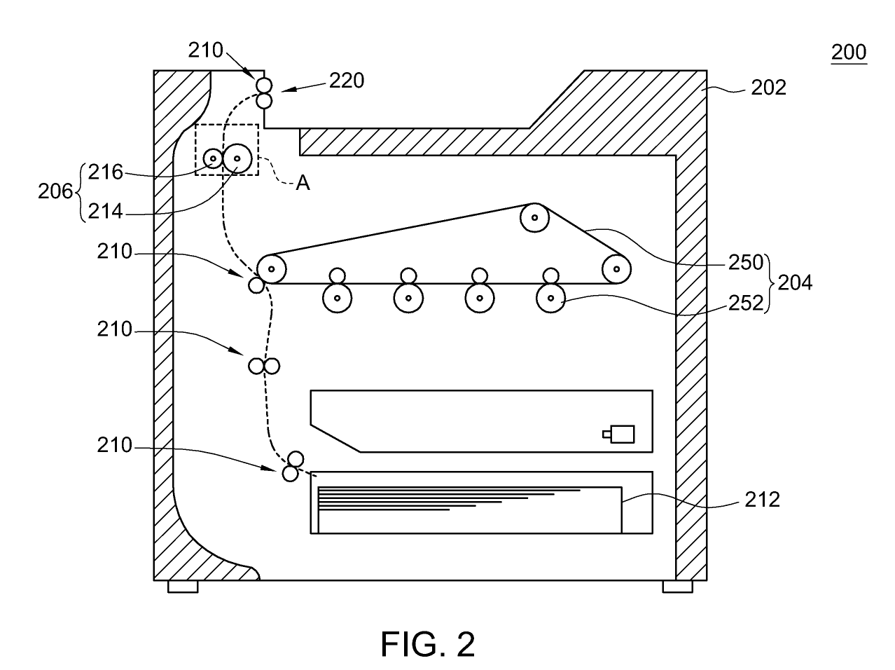

Referring to FIG. 2, a printer is shown. The printer 200, such as a laser printer, includes a casing 202, an imaging forming device 204, a fusing device 206, a paper guiding mechanism 208 (not illustrated in FIG. 2) and a transporting mechanism 210.

The imaging forming device 204 includes an intermediate transfer belt assembly 250 and a plurality of photosensitive drums 252 disposed in the casing 202. The imaging forming device 204 is used for forming an image (not illustrated) on a recording medium, such as a sheet of paper 212.

The fusing device 206 is disposed in the casing 202 for fixing the toner image onto paper 212. The fusing device 206 includes a fixing member 214, such as a heating roller, and a pressurizing member 216, such as a pressurizing roller. Paper 212 is delivered to pass through the nip between the fixing member 214 and the pressurizing member 216.

The transporting mechanism 210, including sets of rollers disposed in the casing 202, is used for transporting paper 212, sequentially past the imaging forming device 204, the fusing device 206 and the paper guiding mechanism 208 (not illustrated in FIG. 2), and then to a paper exit 220.

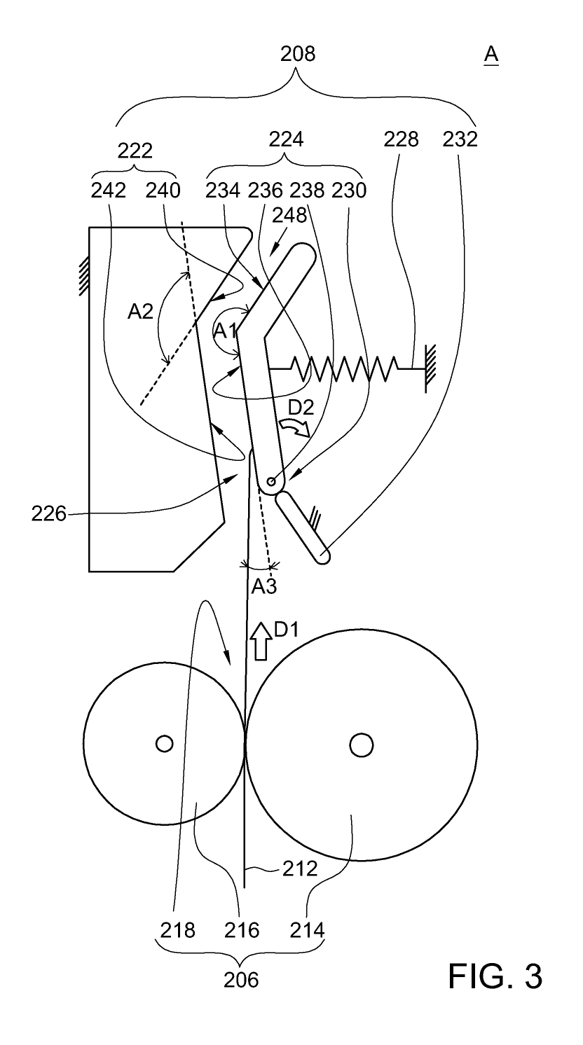

Referring to FIG. 3, an enlargement of area A of FIG. 2 and an embodiment of the paper guiding mechanism are shown. The paper guiding mechanism 208 is disposed in the casing 202 (illustrated in FIG. 2) and located at an exiting end 218 of the fusing device 206 for guiding paper 212 to the paper exit 220 (illustrated in FIG. 2) of the printer 200. The paper guiding mechanism 208 includes a first guiding member 222, a second guiding member 224, an elastic member 228 and a third guiding member 232.

The first guiding member 222 is fixed on the casing 202, and the second guiding member 224 is movably attached to the casing 202. A passage 226 is formed between the first guiding member 222 and the second guiding member 224 for paper 212 to pass through.

Furthermore, the second guiding member 224 has a first plane 234 and a second plane 236, wherein the first plane 234 and the second plane 236 are interconnected and contain a first angle A1. The first guiding member 222 has a third plane 240 and a fourth plane 242, wherein the third plane 240 and the fourth plane 242 are interconnected and contain a second angle A2. The first guiding member 222 is disposed opposite the first plane 234 and the second plane 236. That is, the third plane 240 and the fourth plane 242 are disposed opposite the first plane 234 and the second plane 236, and a passage 226 is formed. Preferably, the first angle A1 is greater than 180 degrees, and the second angle A2 is smaller than 180 degrees. Furthermore, the first angle A1 and the second angle A2 can be designed to adapt to the location of the paper exit 220 of the printer 200, so that the passage 226 extends towards the paper exit 220 (illustrated in FIG. 2) of the printer 200, and paper 212 passing through the passage 226 can be smoothly dispensed from the paper exit 220.

Moreover, paper 212 is transported in a transporting direction D1 to leave the fusing device 206. The included angle A3 between an axis of the transporting direction D1 and the second plane 236 of the second guiding member 224 is smaller than 90 degrees, so that paper 212 can slide into the passage 226 with less chance of being curled and deformed. In the present embodiment of the invention, the transporting direction D1 refers to the tangent direction at the nip point between the heating roller (the fixing member) 214 and the pressurizing roller (the pressurizing member) 216.

Also, the second guiding member 224 is pivotally fixed to the casing 202 at one end 230. For example, a pivot 238 of the second guiding member 224 is disposed in the casing 202. Thus, the second guiding member 224 rotates in a direction D2 to accommodate a force applied by paper 212 and guides paper 212 through the passage 226. Thus, the second guiding member 224 of the present embodiment of the invention is pushed to move by paper 212, so that the leading edge of paper 212 will not be crumpled and the delivery of paper 212 will not be affected.

For example, some types of paper are thicker or heavier than regular printing paper and generate a large force on pushing the second guiding member 224. The second guiding member 224 can be deviced to possess the flexibility compatible with the pressure exerted by any type of thick and heavy paper, such that the leading edge of paper will not be curled and deformed.

The third guiding member 232 is fixed to the casing 202 and located upstream of the second guiding member in a transporting direction of paper 212 for guiding paper 212 emerging from the fusing device 206 to enter the passage 226. Furthermore, as the user may use different types of paper which may have different basis weights and thicknesses, it is not guaranteed that the leading edge of every type of paper will come into contact with the second guiding member 224 first. When a sheet of thinner or lighter paper is delivered from the exiting end 218 of the fusing device 206, the sheet of paper comes into contact with the third guiding member 232 first, and then paper is guided to the second guiding member 224. Thus, the disposition of the third guiding member 232 assures that each paper is smoothly guided to enter the passage 226.

The elastic member 228 connects the second guiding member 224 and the casing 202. The elastic member 228 provides an elasticity restoring force to the second guiding member 224. That is, when the second guiding member 224 is pushed by paper 212, the elastic member 228 generates an elasticity restoring force, and after paper 212 passes through the passage 226, the elasticity restoring force restores the second guiding member 224 to its original position to continue guiding a successive sheet of paper. Thus, the elastic member 228 enables the second guiding member 224 to return to its original position, such each paper passing through the passage 226 may be in contact with the second guiding member 224 at a best angle.

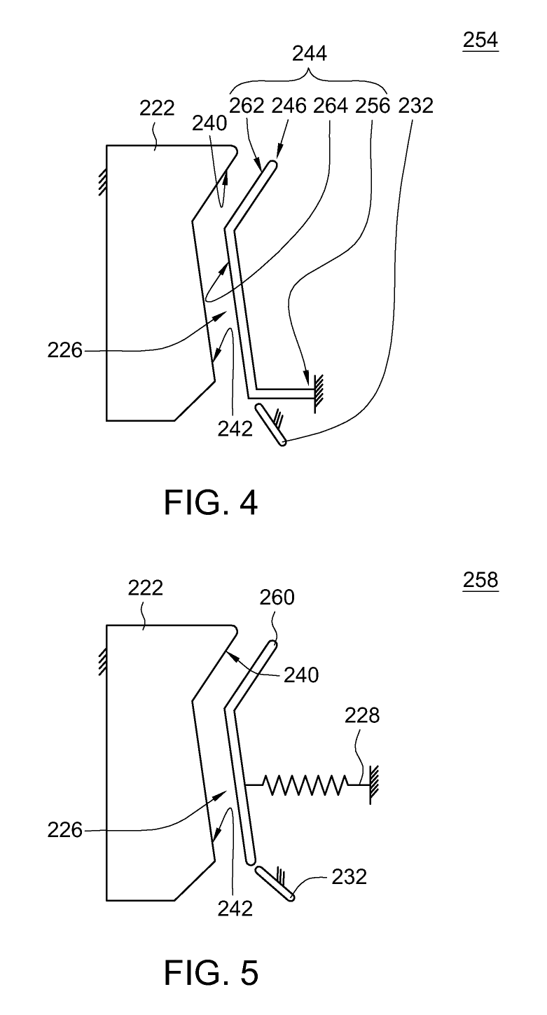

In the present embodiment of the invention, the second guiding member 224 rotates about the rotation pivot 238, but in other embodiments, the second guiding member 224 can perform without using the rotation pivot 238. Referring to FIG. 4, a second embodiment of the paper guiding mechanism is shown. A second guiding member 244 of the paper guiding mechanism 254 is a flexible elastic piece. One end 256 of the elastic piece is fixed on the casing 202, and the other end 246 is a free end. When receiving the force applied by paper 212, the elastic piece bends and deforms, to guide paper 212 through the passage 226. Moreover, when receiving the force applied by paper 212, the elastic piece generates an elasticity restoring force. After paper 212 passes through the passage 226, the elasticity restoring force enables the second guiding member 224 to return to its original position to continue guiding a successive sheet of paper.

Referring to FIG. 5, a third embodiment of the paper guiding mechanism is shown. A second guiding member 260 of the paper guiding mechanism 258 is connected to the casing 202 through the elastic member 228. The second guiding member 244 of FIG. 4 and the second guiding member 260 of FIG. 5 are able to guide paper without using the rotation pivot 238. Thus, as the second and third embodiments of the paper guiding mechanism do not include the rotation pivot 238, the configuration of the paper guiding mechanism becomes more versatile. The second guiding member 244 of FIG. 4 generates an elasticity restoring force without using the elastic member 228, hence saving the relative costs.

The relative position of the second guiding member 244, 260 to the first guiding member 222 is similar to that in the first embodiment as shown in FIG. 3. A first plane 262 and a second plane 264 of the second guiding member 244 are disposed opposite a third plane 240 and a fourth plane 242 of the first guiding member 222 to form a passage 226 through which paper 212 is transported. Likewise is the second guiding member 260 of FIG. 5.

Some of the advantages of the paper guiding mechanism and the printer using the paper guiding mechanism disclosed in the above embodiments of the invention are exemplified as follows:

(1) Through the use of a movable guiding member, such as the second guiding member 224, 244 or 260, paper will not be crumpled and can be delivered smoothly.

(2) The elastic member 228 stores an elasticity restoring force, which enables the second guiding member 224 to return to its original position to continue guiding a successive sheet of paper.

(3) The second guiding member can be a flexible elastic piece. Thus, in the absence of an additional elastic member, the second guiding member still can be restored to its original position to continue guiding a successive sheet of paper.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A paper guiding mechanism disposed in a casing of a printer and located at an exiting end of a fusing device of the printer for guiding a recording medium to a paper exit of the printer, wherein the paper guiding mechanism comprises:
a first guiding member disposed in the casing; and
a second guiding member movably attached to the casing, wherein a passage is formed between the first guiding member and the second guiding member for the recording medium to pass through, and the second guiding member moves in response to a force applied by the recording medium and guides the recording medium through the passage.

2. The paper guiding mechanism according to claim 1, further comprising:
an elastic member for connecting the second guiding member and the casing and providing an elasticity restoring force to the second guiding member.

3. The paper guiding mechanism according to claim 1, wherein the second guiding member is pivotally fixed to the casing at one end.

4. The paper guiding mechanism according to claim 1, wherein the second guiding member is a flexible elastic piece.

5. The paper guiding mechanism according to claim 4, wherein one end of the elastic piece is fixed on the casing and the other end is a free end, wherein when the elastic piece receives the force applied by the recording medium, the elastic piece bends and generates an elasticity restoring force.

6. The paper guiding mechanism according to claim 1, further comprising:
a third guiding member fixed to the casing and located upstream of the second guiding member in a transporting direction of the recording medium for guiding the recording medium to enter the passage.

7. The paper guiding mechanism according to claim 1, wherein the second guiding member comprises:
a first plane; and
a second plane;
wherein the first plane and the second plane are interconnected and contain a first angle; and
the first guiding member is disposed opposite the first plane and the second plane, and the first guiding member forms the passage with the first plane and the second plane.

8. The paper guiding mechanism according to claim 7, wherein the first guiding member comprises:
a third plane; and
a fourth plane;
wherein the third plane and the fourth plane are interconnected and contain a second angle; and
the third plane and the fourth plane are disposed opposite the first plane and the second plane, and the third plane and the fourth plane form the passage with the third plane and the fourth plane.

9. The paper guiding mechanism according to claim 8, wherein the first angle is greater than 180 degrees and the second angle is smaller than 180 degrees.

10. A printer, comprising:
a casing;
an imaging forming device disposed in the casing, for forming an toner image on a recording medium;
a fusing device disposed in the casing for fixing the toner image onto the recording medium;
a paper guiding mechanism disposed in the casing and located at an exiting end of the fusing device for guiding the recording medium to a paper exit of the printer, wherein the paper guiding mechanism comprises:
a first guiding member disposed in the casing; and
a second guiding member movably attached to the casing, wherein a passage is formed between the first guiding member and the second guiding member for the recording medium to pass through, and the second guiding member moves in response to a force applied by the recording medium and guides the recording medium through the passage; and
a transporting mechanism disposed in the casing for transporting the recording medium sequentially past the image forming device, the fusing device and the paper guiding mechanism and then to the paper exit of the printer.

11. The printer according to claim 10, wherein the paper guiding mechanism further comprises:
an elastic member for connecting the second guiding member and the casing;
wherein the elastic member is used for providing an elasticity restoring force to the second guiding member.

12. The printer according to claim 10, wherein the second guiding member is pivotally fixed to the casing at one end.

13. The printer according to claim 12, wherein the paper guiding mechanism further comprises:
an elastic member for connecting the second guiding member and the casing and providing an elasticity restoring force to the second guiding member.

14. The printer according to claim 10, wherein the second guiding member is a flexible elastic piece.

15. The printer according to claim 14, wherein one end of the elastic piece is fixed on the casing, and the other end is a free end, wherein when the elastic piece receives the force applied by the recording medium, the elastic piece bends and generates an elasticity restoring force.

16. The printer according to claim 10, wherein the paper guiding mechanism further comprises:
a third guiding member fixed to the casing and located upstream of the second guiding member in a transporting direction of the recording medium for guiding the recording medium to enter the passage.

17. The printer according to claim 10, wherein the second guiding member comprises:
a first plane; and
a second plane;
wherein the first plane and the second plane are interconnected and contain a first angle; and
the first guiding member is disposed opposite the first plane and the second plane, and the first guiding member forms the passage with the first plane and the second plane.

18. The printer according to claim 17, wherein the first guiding member comprises:
a third plane; and
a fourth plane;
wherein the third plane and the fourth plane are interconnected and contain a second angle; and
the third plane and the fourth plane are disposed opposite the first plane and the second plane, and the third plane and the fourth plane form the passage with the first plane and the second plane.

19. The printer according to claim 18, wherein the first angle is greater than 180 degrees, and the second angle is smaller than 180 degrees.

20. The printer according to claim 10, wherein the recording medium is transported in a transporting direction to leave the fusing device, and the included angle between an axis of the transporting direction and a plane of the second guiding member is smaller than 90 degrees.
